(19) United States
(12) Patent Application Publication
(10) Pub. No.: US 2006/0234725 A1
(43) Pub. Date: Oct. 19, 2006

(54) Celluar based location of wireless local area networks

(76) Inventor: Louis Robert Litwin, Plainsboro, NJ (US)

Correspondence Address: THOMSON LICENSING INC., PATENT OPERATIONS, PO BOX 5312, PRINCETON, NJ, 08543-5312, US

(21) Appl. No.: 10/567,677

(22) PCT Filed: Aug. 22, 2003
(86) PCT No.: PCT/US03/26464

§ 371 Date: Feb. 9, 2006

(51) Int. Cl. H04Q 7/20

(52) U.S. Cl. 455/456.2; 455/456.1

(57) ABSTRACT

A method for locating a wireless local area network WLAN transmitting a request to a wireless service provider of a wireless network for a location of the wireless local area network (WLAN), and receiving from the wireless service provider the location of the wireless local area network (WLAN). An apparatus includes a wireless transceiver for transmitting and receiving communication over a wireless network, and a controller for processing a request for a location of a wireless local area network WLAN and processing receiving from over the wireless network the location of the wireless local area network WLAN.

### BACKGROUND OF THE INVENTION

1. Field of the Invention

The present invention generally relates to communication systems and, more particularly, to cellular based locating of a wireless local area network.

2. Description of the Related Art

Presently, 2.5 generation (2.5G) and third generation (3G) cellular networks can provide wireless data service, such as wireless Internet service, having data rates up to 2 Mbps. On the other hand, wireless local area networks (WLANs), such as IEEE 802.11a, IEEE 802.11b, and HiperLAN/2 wireless networks, for example, can provide data service with rates higher than 10 Mbps. WLAN service is also typically cheaper to implement than cellular service due to the use of unlicensed frequency bands by WLANs. As such, it is desirable to switch from cellular service to WLAN service when a mobile device is within the service area of a WLAN. Switching between cellular service and WLAN service can provide for optimal utilization of the available spectrum, and can reduce the burden on cellular networks during times of peak activity.

A common problem for users with WLAN-enabled mobile devices, such as cell phones, PDAs, etc., is how to locate nearby public WLAN hotspots. Thus, there is a need for aiding the user in finding WLAN locations.

### SUMMARY OF THE INVENTION

A method for locating a wireless local area network WLAN includes transmitting a request to a wireless service provider of a wireless network for a location of a wireless local area network (WLAN) and receiving from the wireless service provider the location of the wireless local area network (WLAN). Preferably, after the step of transmitting the wireless service provider determines a wireless service area from which the transmitting originated and the wireless service provider obtains the location of the wireless local area network WLAN based on the wireless service area. Preferably, the wireless network is a cellular telephone network.

In accordance with another aspect of the invention an apparatus includes a wireless transceiver for transmitting and receiving communication over a wireless network; and a controller for processing a request over the wireless network for a location of a wireless local area network WLAN and processing receiving over the wireless network the location of the wireless local area network WLAN. Preferably, the apparatus further includes wireless local area network WLAN baseband circuitry for communicating over a WLAN. In one embodiment, the controller processes the request for the location of the wireless local area network WLAN based on a user provided location.

### BRIEF DESCRIPTION OF THE DRAWINGS

So that the manner in which the above recited features of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 depicts a communication system in accordance with the present invention;

FIG. 2 depicts a high-level block diagram showing one embodiment of a mobile device in accordance with the present invention; and

FIG. 3 depicts a flow diagram showing one embodiment of a method for cellular based locating of a WLAN.

### DETAILED DESCRIPTION

The present invention is a method and apparatus for cellular based locating of a wireless local area network (WLAN). The present invention will be described within the context of communications between a mobile device and a wireless network for the purposes of informing the mobile device user of a WLAN location known to a service provider for the wireless network. An exemplary mobile device and wireless network are a cell phone and a cellular network. Those skilled in the art, however, will appreciate that the present invention can be advantageously employed in any communication device that is capable of communicating with any type of wireless network. Thus, the present invention has broad applicability beyond the cellular network communication references mentioned herein.

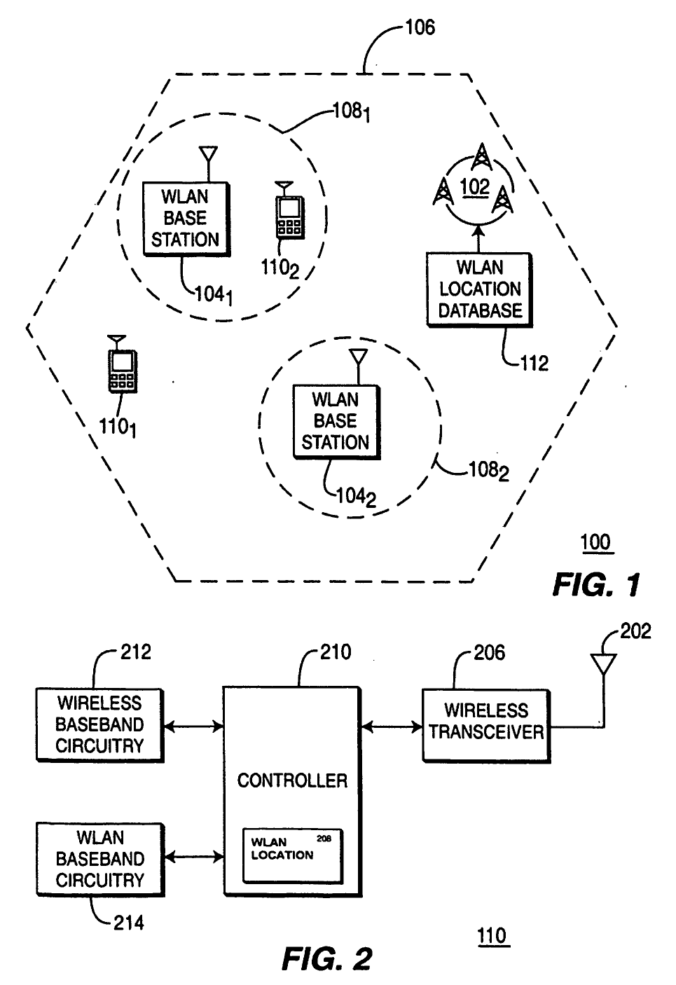

FIG. 1 depicts a communication system 100 in accordance with the present invention. The communication system 100 comprises a wireless communication network 102, a plurality of WLAN access points 104 (e.g., WLAN access points 104₁ and 104₂), a WLAN location database 112, and a plurality of mobile devices 110 (e.g., mobile devices 110₁ and 110₂). The wireless communication network 102 provides service to mobile devices 110 located within a wireless service area 106 (e.g., mobile devices 110₁ and 110₂). For example, the wireless communication network 102 can comprise a cellular telephone network providing voice and/or data services to mobile devices 110 within the service area 106.

The WLAN access points 104₁ and 104₂ provide service to mobile devices 110 located within service areas, i.e., hotspots, 108₁ and 108₂, respectively (e.g., mobile device 110₂ located within service area 108₁). For example, the WLAN access points 104 can comprise IEEE 802.11b WLAN access points providing voice and/or data services to mobile devices 110 within the service areas 108. The location of each of the WLAN access points 104 is stored within the WLAN location database 112. For example, the WLAN location database 112 can store the coordinates (e.g., longitude and latitude) for each of the WLAN access points 104 along with the extent of the service areas 108. The communication system 100 is illustratively shown having non-overlapping service areas 108 corresponding to the WLAN access points 104 that are located with the service area 106. Other arrangements can be used with the present invention, such as overlapping service areas or hotspots 108.

WLAN service areas, such as 108₁ and 108₂, can be registered with cellular service providers maintaining a database of the hotspots 108 and their physical locations. Preferably, physical locations of WLAN hotspots are in the form of street addresses, map locations, longitude and latitude, global positioning coordinates, and other location identification formats. When a user is looking for a WLAN hotspot 108, the user can select a menu option on the mobile device that transmits a message, via the wireless network 102, to a wireless service provider 102. The service provider for the wireless 102 can obtain a rough estimate of the user's location based on which wireless service area the mobile device 110 is communicating from. The wireless network service area 106 can then be compared to the WLAN location database 112 to find a user-defined listing of WLAN locations and their physical addresses. This list of physical location addresses can then be sent to the mobile device 110. The mobile device user can choose from the list of physical addresses a desired WLAN location 108 and move towards that desired WLAN location in order to communicate with a WLAN base station 104. A WLAN database 112 can contain WLAN locations or service areas outside the wireless service area 106 and provide a mobile device user with their locations as well.

Each of the mobile devices 110 is capable of communicating with the service provider of the wireless network 106 for locating a WLAN hotspot or service area. A cell phone user calling out of a particular wireless network cell can transmit a WLAN location request to the cell phone service provider. The cell phone service provider can then compare the cell from which the user is calling against a database of known WLAN locations and transmit back to the cell phone user a listing of the WLAN locations and addresses. As such, the present invention permits a user of a cell phone 110 to move towards a WLAN service area 108 for access to WLAN broadband communication.

FIG. 2 depicts a high-level block diagram showing an exemplary embodiment of a mobile device 110 in accordance with the present invention. The mobile device 110 comprises a wireless transceiver 206 coupled to an antenna 202, a controller 210 configured with inventive WLAN location processing 208, wireless baseband circuitry 212, and WLAN baseband circuitry 214. Wireless baseband circuitry 212 processes signals associated with a wireless communication system, such as cellular telephone signals. WLAN baseband circuitry 214 processes signals associated with a WLAN, such as IEEE 802.11b WLAN signals. The WLAN baseband circuitry is not necessary for practicing the inventive cellular based locating of a wireless local area network WLAN and is shown in FIG. 2 as an optional function block that would make it convenient for the same mobile device to communicate over both wireless 106 and WLAN 108 service areas. Wireless transceiver 206 transmits and receives radio frequency (RF) signals that are processed by the wireless baseband circuitry 212 or the WLAN baseband circuitry 214 through the controller 210. For example, the mobile device 110 can comprise a cellular telephone having a WLAN plug-in card (e.g., a personal computer memory card internal association (PCMCIA) plug-in card). In another example, the mobile device 110 can comprise a personal digital assistant (PDA) or a laptop computer with a WLAN and plug-in card.

The controller 210 can comprise a processor coupled between the wireless baseband circuitry 212, the WLAN baseband circuitry 214, and the wireless transceiver 206. In this embodiment, the controller 210 is programmed to perform various control functions in accordance with the present invention. More specifically, the controller 210 is programmed to perform WLAN location processing 208. For example, WLAN location processing of requests to the service provider of the wireless network service area 106 and processing WLAN location related information received from the service provider. Those skilled in the art will appreciate, however, that the invention can be implemented in hardware, for example, as an application specific integrated circuit (ASIC). As such, the process steps described herein are intended to be broadly interpreted as being equivalently performed by software, hardware, or a combination thereof. Furthermore, although the controller 210 is depicted as a separate functional block, those skilled in the art will appreciate that the wireless baseband circuitry 212 and/or the WLAN baseband circuitry 214 can be adapted to perform the functions of the controller 210. Also WLAN location processing 208 can be incorporated in an application specific integrated circuit ASIC.

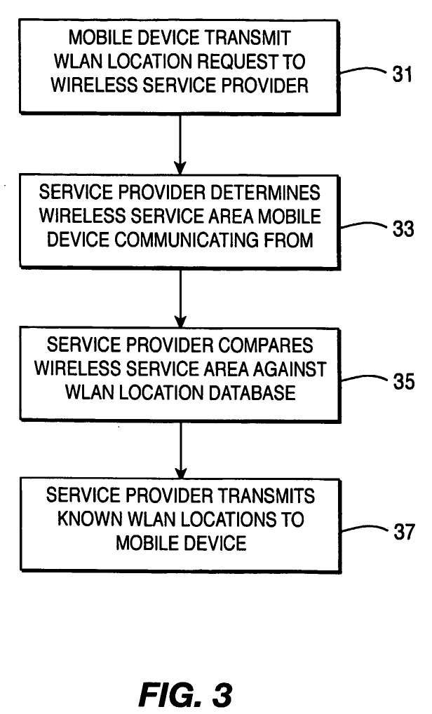

FIG. 3 depicts a flow diagram showing an exemplary embodiment of a method 300 for wireless or cellular based locating of a WLAN service area, such as 108. The method 300 can be best understood with simultaneous reference to FIGS. 1 and 2. The method 300 begins at step 31 when the mobile device 110 is enabled to transmit a request to the wireless service provider for locations of WLAN service areas. Preferably, a mobile device such as a cell phone is configured with a menu option to locate nearby WLAN service areas. When the menu option for locating WLAN service area locations is selected the mobile device can then transmit the request to the service provider.

At step 33, service provider of wireless network can readily determine the wireless service area or cell 106 is communicating from. A service provider, such as a cellular service provider, can estimate the mobile device user's location from the cellular network cell the user is calling from.

At step 35, the service provider compares the wireless service area the mobile device 110 is communicating within against WLAN service areas or locations stored in its database 112. The WLAN database can store WLAN locations with a cross reference to their street addresses, map coordinates, global positioning coordinates, or latitude and longitude coordinates.

At step 37, the wireless or cellular provider can then transmit back to the mobile device a message containing a listing of WLAN locations or service areas defined by the user of the mobile device. The mobile device can be configured to search for WLAN locations within a predefined distance from the wireless service area or cell the user is calling from. Alternatively, the user can be provided with a menu option selection in the mobile device 110 for selecting a distance or distance range from his wireless service area containing WLAN service area locations. Once a mobile device or cell user receives locations of WLAN service areas the user can then proceed to move towards a WLAN service area location transmitted back by the wireless service provider.

While the foregoing is directed to the preferred embodiment of the present invention, other and further embodiments of the invention may be devised without departing from the basic scope thereof, and the scope thereof is determined by the claims that follow.

1. A method, comprising:
transmitting (31) a request to a wireless service provider of a wireless network for a location of a wireless local area network (WLAN); and
receiving (37) from said wireless service provider said location of said wireless local area network (WLAN).

2. The method of claim 1, further comprising after said step of transmitting said wireless service provider determining (33) a wireless service area from which said transmitting originated.

3. The method of claim 2, further comprising after said step of determining said wireless service provider obtaining (35) said location of said wireless local area network WLAN based on said wireless service area.

4. The method of claim 1, wherein said wireless network is a cellular telephone network (102).

5. The method of claim 1, wherein said request for a location of a wireless local area network WLAN comprises requesting a location of a wireless local area network WLAN relative to a specific location.

6. The method of claim 1, wherein said location of said wireless local area network WLAN comprises one of a street address, a map location, longitude and latitude coordinates, and global positioning coordinates.

7. An apparatus, comprising:
a wireless transceiver (206) for transmitting and receiving communication over a wireless network; and
a controller (210) for processing a request over said wireless network for a location of a wireless local area network WLAN (104) and processing receiving over said wireless network said location of said wireless local area network WLAN (104).

8. The apparatus of claim 7, further comprising wireless baseband circuitry (212) and WLAN baseband circuitry (214).

9. The apparatus of claim 7, wherein controller (210) processes said request for said location of said wireless local area network WLAN based on a user provided location.

10. The apparatus of claim 7, wherein said controller (210) processes said receiving of said location of said wireless local area network WLAN by displaying said location as one of a street address, map coordinates, longitude and latitude, and global positioning coordinates.

11. The apparatus of claim 7, wherein said wireless transmitter (206) and said controller (210) are within a cellular communication device.

14. The apparatus of claim 7, wherein said wireless network is a cellular telephone network.

15. A communications system comprising:
a wireless network (102) for providing wireless communication services over a wireless service area (106), and
a mobile device (110) for sending a request from said wireless service area across said wireless network for a location of a wireless local area network WLAN.

16. The communication system of claim 15, wherein said location of said wireless local area network WLAN is based on a location of said wireless service area.

17. The communication system of claim 15, wherein said location of said WLLAN comprises one of a street address, map coordinates, latitude and longitude, and global positioning coordinates.

18. The communication system of claim 15, wherein said wireless network (102) comprises a cellular telephone network.

19. The communication system of claim 15, wherein said mobile device comprises a cellular telephone.

20. The communication system of claim 15, wherein said mobile device comprises processing for receiving said location of said wireless local area network WLAN.
